(19) United States
(12) Patent Application Publication
(10) Pub. No.: US 2003/0107656 A1
(43) Pub. Date: Jun. 12, 2003

(54) Image pick-up device and portable electronic device having the same

(76) Inventors: Akira Ito, Narashino-shi (JP); Yoichi Seki, Narashino-shi (JP); Yoichi Nakano, Narashino-shi (JP); Hirobumi Okuyama, Narashino-shi (JP)

Correspondence Address: ADAMS & WILKS, 31st Floor, 50 Broadway, New York, NY, 10004, US

(21) Appl. No.: 10/314,622

(22) Filed: Dec. 9, 2002

(30) Foreign Application Priority Data
Dec. 7, 2001 (JP) 2001-374026

(51) Int. Cl. H04N 5/335; H04M 1/00

(52) U.S. Cl. 348/216.1; 348/370; 348/221.1; 348/311; 455/556

(57) ABSTRACT

To reduce power consumption of an image pick-up device in which an object to be photographed is illuminated, during a period until a release switch is operated, a control part controls a light emitting part to emit a smaller quantity of light than that necessary for photographing the object. When a photographing instruction is output by the release switch, the control part controls the light emitting part to emit light with the quantity of light necessary for photographing the object.

### FIELD OF THE INVENTION

The present invention relates to an image pick-up device and a portable electronic device such as a portable telephone having the image pick-up device and, more particularly, to an image pick-up device capable of illuminating an object to be photographed and to a portable electronic device such as a portable telephone having the image pick-up device.

### BACKGROUND DISCUSSION

In recent years, digital still cameras using image sensors such as CCDs have been widely used. Most known digital still cameras display photographed images picked up by the image sensors during operation of the camera on a display of some sort, such as an LCD panel. After a user recognizes the displayed image, the user presses a release button to photograph the image, so that the user obtains a photograph having a desired composition. Conventional silver salt cameras cannot perform this function, which is unique to digital still cameras.

The above-described function may be desirable in bright light. However, when the image is dark, the display of the image is too dark to see so that the above-described function cannot be realized. In such a case, only the photographer's visual recognition can be relied on. However, in dark ambient light, the photographer cannot visually recognize an object to be photographed. In order to overcome these drawbacks, a light may be turned on continuously from the beginning of the camera operation to the completion of a photographing operation. However, when such a light is turned on continuously at a luminance level necessary for photographing an object, the amount of consumed electric power is drastically increased.

### SUMMARY OF THE INVENTION

It is an object of the present invention to reduce the power consumed by an image pick-up device having a light so that a photographer can recognize an object to be photographed even in dark ambient light.

In accordance with a first aspect of the present invention, an image pick-up device is provided with a release switch for outputting an instruction for photographing a still image, an image pick-up part for picking up the image of an object to be photographed, updating and outputting image information corresponding to the picked-up image of the object to be photographed until the release switch is operated and outputting as still image information an image signal corresponding to the image of the object which is picked up when the release switch is operated, a light emitting part for illuminating the object to be photographed, and a light quantity control part for changing the quantity of light output by the light emitting part between a period until the release switch is operated and a time when the still image is photographed in accordance with the operation of the release switch.

By the foregoing structure, the high level of light needed for photographing the still image is generated only when the still image is photographed. Before the still image is photographed, the light generated by the light emitting part is no larger than needed for the photographer to recognize the object to be photographed. Thus, power consumption can be reduced as compared to the case in which the quantity of light necessary for photographing the still image is continuously applied during the entire operation.

In accordance with a second aspect of the invention, the light quantity control part allows the quantity of light of the light emitting part upon photographing the still image in accordance with the operation of the release switch to be increased more than the quantity of light of the light emitting part during a period until the release switch is operated. According to such a structure, the quantity of light of the light emitting part upon photographing the still image in accordance with the operation of the release switch can be increased more than the quantity of light of the light emitting part during the period until the release switch is operated, in addition to the above-described effect.

In accordance with a third aspect of the present invention, the image pick-up device further comprises a display for displaying the image information output by the image pick-up part. According to such structure, even in dark ambient light during a period until the release switch is operated, a photographer can recognize the image displayed on the display part in addition to the above-described effects. After the photographer recognizes the image, the photographer can press a release button to carry out a still image photographing operation.

In accordance with a fourth aspect of the present invention, the light emitting part is an LED. According to such structure, the device can be made compact in addition to the above-described effects.

A fifth aspect of the invention concerns a portable electronic device equipped integrally with the above-described image pick-up device. According to such a structure, a portable electronic device having the same effects as described above can be realized.

### BRIEF DESCRIPTION OF THE DRAWINGS

FIG. 1 is a functional block diagram showing one embodiment of the present invention;

FIG. 2 is a block diagram showing a CCD camera in FIG. 1;

FIG. 3 is a front view showing an external appearance of the one embodiment of the present invention;

FIG. 4 is a timing chart for explaining an operation of FIG. 1; and

FIG. 5 is a timing chart for explaining the operation of FIG. 1.

### DETAILED DESCRIPTION OF THE PREFERRED EMBODIMENTS

Now, one mode for carrying out the present invention will be described with reference to embodiments shown in the drawings. In one embodiment, the invention will be described in the context of an image pick-up device incorporated in or provided with a portable electronic device comprising a portable telephone.

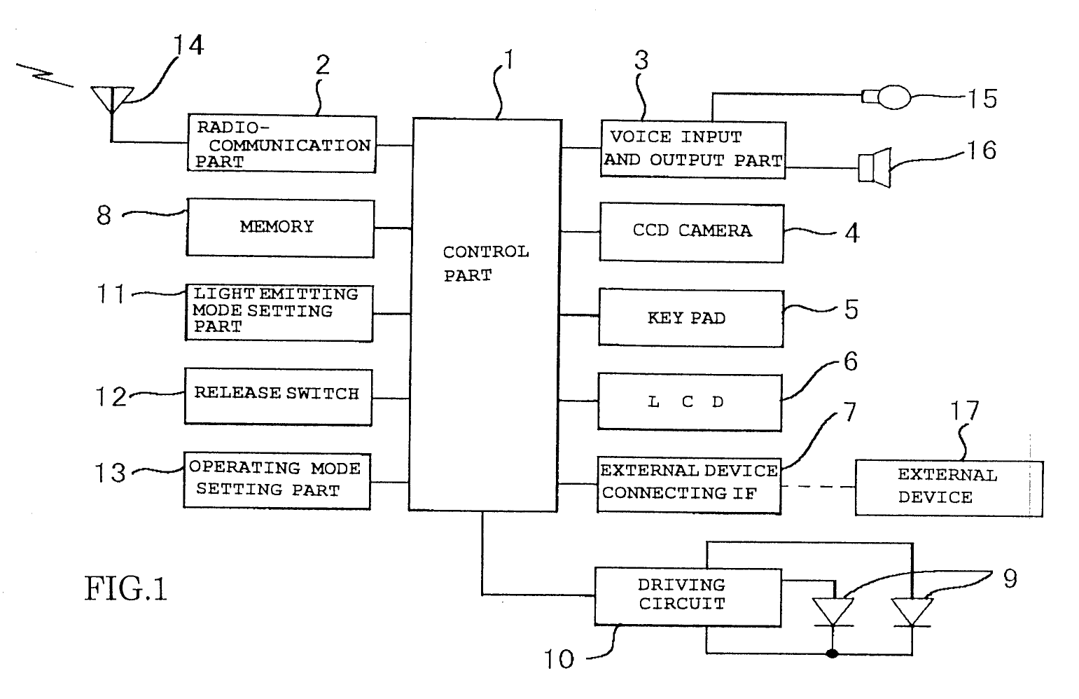

FIG. 1 is a functional block diagram showing the structure of the portable telephone. In the drawing, a control part 1 serves as a light quantity control part and comprises a microcomputer including a CPU, or the like, as a main component. A radio-communication part 2 is connected thereto, as is a voice input and output part 3, a CCD camera 4 serving as an image pick-up part, a keypad 5, a color LCD panel 6 serving as a display part, and an external device connecting interface (IF) 7, each of which is illustrated on the right-hand side of the control part 1 in FIG. 1.

Also connected to the control part 1 and shown below the control part in FIG. 1 is a driving circuit 10 for driving a white LED 9 serving as a light emitting part for generating light to illuminate an object to be photographed. As shown on the left-hand side of the control part 1 of FIG. 1, also connected to the control part 1 are a memory 8, a light emitting mode setting part 11 for setting the light emitting mode of the LED 9, a release switch 12 for outputting a release signal as instruction to photograph an object, and an operating mode setting part 13 serving as a power switch.

An antenna 14 is connected to the radio-communication part 2. The voice input and output part 3 has a microphone 15 and a receiver 16 connected thereto.

When a transmitting voice is input, the microphone 15 converts it from an audio signal to an electrical signal, generates a voice transmitting signal, and outputs the voice transmitting signal to the voice input and output part 3. When the voice transmitting signal is supplied to the voice input and output part 3 from the microphone 15, the voice input and output part 3 amplifies and A/D converts the voice transmitting signal, and outputs the converted voice transmitting signal to the radio-communication part 2 through the control part 1. When the voice transmitting signal is supplied to the radio-communication part 2 from the voice input and output part 3 through the control part 1, the radio-communication part 2 performs known baseband and wireless communications processing on the voice transmitting signal and emits a broadband radio wave in a communication frequency band (for instance, a communication frequency band allocated to radio-communication using a code-division multi-origination connection (CDMA) system) or the like from the antenna 14.

When the antenna 14 receives a broadband radio wave in the designated communication frequency band, the radio communication part 2 performs radio and baseband processing on the received radio wave to generate a voice receiving signal, and outputs the voice receiving signal to the voice input and output part 3 through the control part 1. When the voice receiving signal is supplied to the voice input and output part 3 from the radio-communication part 2 through the control part 1, the voice input and output part 3 amplifies and D/A converts the voice receiving signal and outputs it to the receiver 16. The receiver 16 converts the voice receiving signal into an audio signal and outputs a corresponding receiving voice.

The CCD camera 4 picks-up the image of an object to be photographed and generates (by a process referred to as photoelectric transfer) image information corresponding to the photographed image. The image information is output to the control part 1.

The keypad 5 is comprised of various kinds of keys arranged in a desired manner, such as a “start” key, a redial key, an “end” key, numeric keys (including 0-9), an asterisk (*) key, a pound or sharp (#) key and function keys, etc. When one of the keys is pressed, a key operating signal corresponding to the pressed key is output to the control part 1. When the key operating signal is supplied to the control part 1 from the keypad 5, the control part 1 decodes the key operating signal to perform a process corresponding to the decoded result.

When a display signal is supplied to the LCD display panel 6 from the control part 1, the LCD panel 6 displays information corresponding to the supplied display signal.

In a preferred embodiment of the present invention, the external device 17 comprises a digital still camera, or the like, which photographs images similarly to the CCD camera 4. The external device connecting interface (IF) 7 receives the image information photographed by the external device 17 and outputs the received image information to the control part 1 when the portable telephone is connected to the external device 17. The display part is not limited to a color LCD panel and may be suitably changed to an organic EL display, etc.

The memory 8 forms part of the overall control means of the device in conjunction with the control part 1 and may comprise memory devices such as a flash memory, a ROM, a RAM, a VRAM (video RAM), and the like. The memory 8 stores executable programs in ROM. The control part 1 reads the executable programs and performs processes according to the various programs to execute the various operations described below. The flash memory in the memory 8 stores the image information input from the CCD camera 4 upon operation of the release switch 12 and the image information input from the external device connecting interface 7. The VRAM in the memory 8 stores the image information input from the CCD camera 4 and displayed on the LCD panel 6 or the image information input from the external device connecting interface 7. The RAM in the memory 8 is used for various kinds of processes.

The LED 9 serving as the light emitting part is an LED that is capable of illuminating an object to be photographed. In the presently described embodiment, a white LED for applying white light is employed. As the white LED, for instance, a high luminance white LED is used, such as model number:NSPW510BS produced by Nichia Kagaku Kogyo Co., Ltd., or the like. In FIG. 1, although two LEDs 9 are shown, the number of LEDs may be suitably changed. For example, since the quantity of light required for illuminating an object differs depending on the detection characteristics of a CCD (image sensor) used for the CCD camera 4, a change can be made in such a fashion that when a large quantity of light is necessary for lighting, the number of LEDs 9 is increased to increase the quantity of light, and when a large quantity of light for lighting is not necessary, a single LED is used.

The driving circuit 10 drives the LED 9 on the basis of a light quantity control signal output by the control part 1 for controlling the quantity of light emitted by the LED 9. Since the light quantity control signal output by the control part 1 may comprise information for designating the quantity of light to be emitted by a white LED 9, consideration of white balance is not necessary as compared to the case where the quantity of light of the light emitting part for emitting white light is controlled by using a red LED, a green LED and a blue LED. Therefore, the light quantity control signal can be simplified.

The light emitting mode setting part 11 serves to set the light emitting mode of the LED 9. In the presently described embodiment, either an “automatic light emitting mode” in which light emission and quantity are automatically controlled depending on the luminance of an object to be photographed, or a “light emitting inhibit mode” in which light emission by the LED 9 is inhibited can be set. For instance, the modes are switched between the automatic light emitting mode and the light emitting inhibit mode each time the light emitting mode setting part 11 is operated. The control part 1 controls the light emission of the LED 9 in accordance with the mode set by the light emitting mode setting part 11 and displays the set mode on the LCD panel 6.

The operating mode setting part 13 can selectively set a state in which power is turned off (off mode), a state in which the transmitting and receiving operations of a telephone can be carried out (telephone mode), a state (view mode) in which image information stored in the memory 8 is displayed, a state in which a photographing operation by a camera can be carried out (photographing mode) and a state in which the light of the LED (light emitting part) 9 is continuously emitted with a prescribed quantity of light (luminance) (light mode). For instance, the operating modes are switched between the off mode, the telephone mode, the view mode, the photographing mode and the light mode each time the operating mode setting part 13 is operated. The control part 1 controls various operations depending upon the mode set by the operating mode setting part 13 and displays the set mode on the LCD panel 6. A telephone call can be received by the device in all of the aforementioned modes except for the off mode.

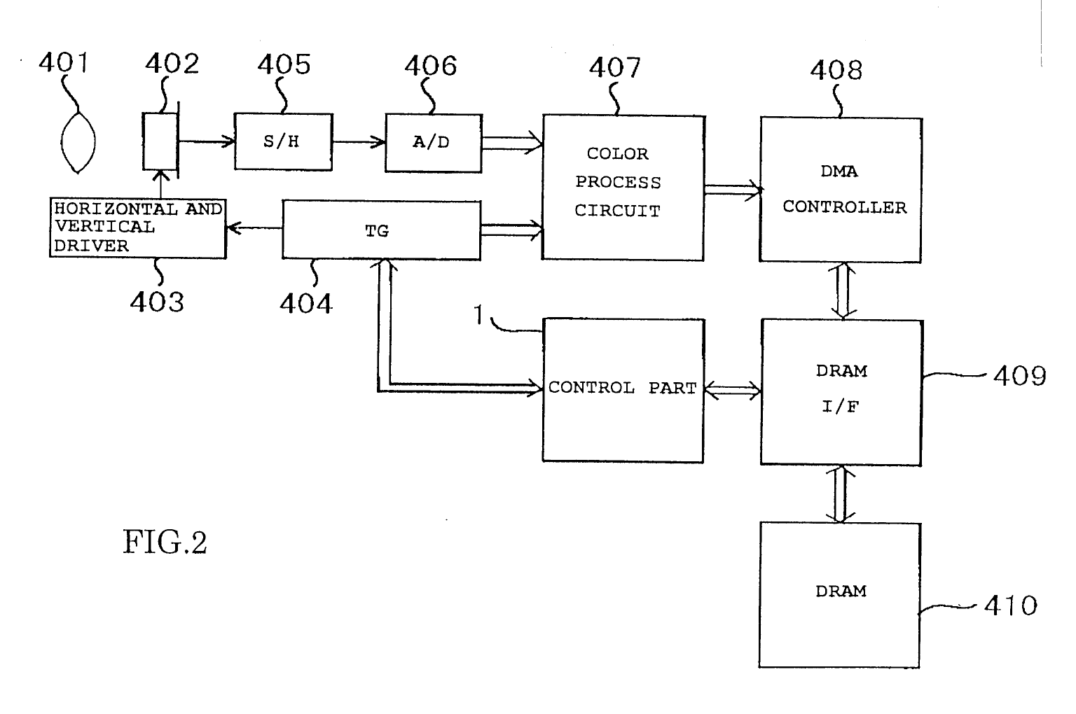

FIG. 2 is a block diagram showing portions of the CCD camera 4, the control part 1, and additional portions of the device. FIG. 2 shows a CCD 402 serving as an image pick-up element having a light receiving surface on which the optical image of an object to be photographed is formed by a photographing lens 401. The CCD 402 is a solidstate image pick-up element which performs a known photoelectric transfer operation for outputting an analog signal corresponding to the optical image and transfers an electric charge in the form of an array. The CCD 402 is a solidstate image sensor which converts two-dimensional optical information into a time-series electric signal (serial row).

The characteristics of the CCD 402 are described below. The CCD 402 includes a photoelectric transfer part in which many photoelectric transfer elements are arranged in the form of an array, a charge storage part for storing the output charges of the photoelectric transfer elements, and a charge reading part for reading the charge stored in the charge storage part in a prescribed system. Each of the photoelectric transfer elements forms a pixel. The CCD 402 in the present embodiment is a color CCD. Generally, since the pixel information itself of the CCD does not have color information, a color filter (a primary color filer using the three primary colors of light or a complementary color filter using the three primary colors) is mounted on the front surface of the color CCD.

A horizontal and vertical driver 403 and a timing generator (TG) 404 generate driving signals necessary for reading the CCD 402. Specifically, the horizontal and vertical driver and the timing generator 404 generate driving signals for transferring (reading) the information of the pixels for each row, while sequentially designating each column of the CCD 402, that is, they generate the horizontal and vertical driving signals respectively for serially reading out the pixel information.

A sample-and-hold (S/H) circuit 405 serves to sample the time-series signal (in this step, an analog signal) read out from the CCD 402 with a frequency adapted to the resolution of the CCD 402. After the sampling operation is performed, automatic gain control (AGC) may be carried out. An analog/digital converter 406 converts the sampled signal into a digital signal.

A color process circuit 407 generates a luminance/color difference multiplex signal (also referred to herein as a “YUV signal”) as the image information from the output of the analog/digital converter 406.

A DMA controller 408 transfers data between the color process circuit 407 and a DRAM 410 (specifically, through a DRAM interface (I/F) 409) without interposing the control part 1, to thereby carry out memory transfer by a so-called direct memory transfer or direct memory access (DMA) operation. The DRAM interface 409 serves as a signal interface between the DRAM 410 and the DMA controller 408 and as a signal interface between the DRAM 410 and the control part 1.

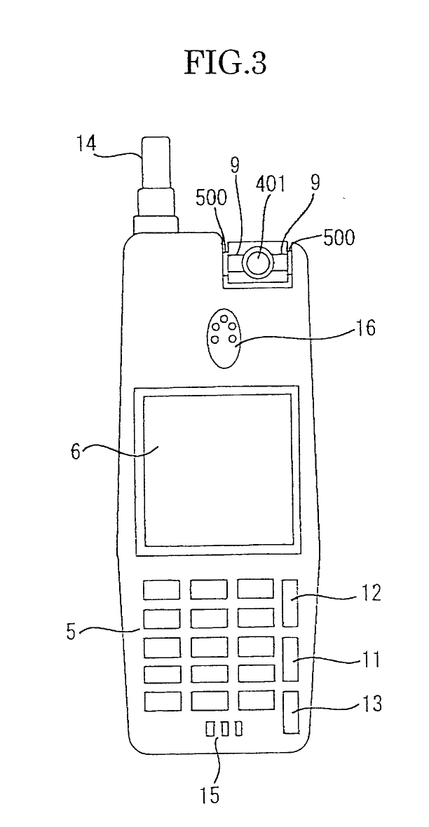

FIG. 3 is a view showing the external appearance of the portable telephone according to the presently described embodiment. In FIG. 3, components which are the same or similar to those of FIGS. 1 and 2 are designated by the same reference numerals. The photographing lens 401, the CCD 402 and the LEDs 9 are integrally formed and capable of turning or rotating about an axis 500. Accordingly, a user can photograph himself or herself using the CCD camera 4. Since the image pick-up device using the LED as the light emitting part is equipped integrally with the portable telephone, noise can be further reduced, the form of the device can be made more compact, and the degree of freedom in design can be improved as compared to the related art using a xenon tube as a light emitting part. Further, since the white LED is used as the light emitting part, the structure can be simplified and the number of parts can be reduced as compared with a device using, for instance, a red LED, a green LED and a blue LED to generate light.

Now, operation of the preferred embodiment will be described.

When the telephone mode is set by the operating mode setting part 13, the control part 1 allows the functions of the portable telephone to be performed using the radio-communication part 2, the voice input and output part 3, the antenna 14, the microphone 15 and the receiver 16 so that the portable telephone can be used in the same manner as an ordinary portable telephone.

When the view mode is set by the operating mode setting part 13, the control part 1 supplies a display signal corresponding to the image information stored in the memory 8 (e.g., the VRAM) to the LCD panel 6 to display an image corresponding to the image information on the LCD panel 6.

When the light mode is set by the operating mode setting part 13, the control part 1 controls the LED 9 to emit a prescribed quantity of light (brightness). Accordingly, when the light mode is set, the portable telephone can be used as a lighting device. Further, as described below, since the LED (light emitting part) 9 used for photographing is also used for lighting, the structure can be simplified. Since the LED is used as the light emitting part, a more compact structure can be realized. In the light mode, the quantity of light of the LED 9 may be adjusted by operating the keypad 5.

When the photographing mode is set by the operating mode setting part, the control part 1 operates the CCD camera 4 to continuously fetch image information corresponding to the image of an object to be photographed. The image is obtained and output in real time by the CCD camera 4, which sends the image information to the LCD panel 6 through the VRAM, or the like, of the memory 8 and displays it on the LCD panel 6. The user determines a desired composition while viewing the LCD panel 6 in this state. At this time, the control part 1 recognizes the setting in the light emitting mode setting part 11.

When an automatic light emitting mode is set by the light emitting mode setting part 11, the control part 1 controls the quantity of light generated by the LED 9 in accordance with the image information input from the CCD camera 4. More specifically, the control part 1 changes a light quantity control signal output to the driving circuit 10 in accordance with a luminance signal included in the image information input from the CCD camera 4 to control the quantity of light generated by the LED 9. In particular the luminance signal indicates a relatively darker state, the control part 1 controls the quantity of light emitted by the LED 9 to be relatively increased so as to apply a stronger light. As an example, when the control part 1 decides that an image displayed on the LCD panel 6 in accordance with the luminance signal is lighter than a prescribed value 1, the control part 1 suppresses the lighting of the LED 9. When the control part 1 decides that the image displayed on the LCD panel 6 in accordance with the luminance signal is darker than the prescribed value 1 and lighter than a prescribed value 2 (in this case, it is assumed that the prescribed value 1 is higher in luminance than the prescribed value 2 and these values are previously stored in the memory 8.), the control part 1 controls the LED 9 to be turned on with a first quantity of light. When the control part 1 decides that the image displayed on the LCD panel 6 in accordance with the luminance signal is darker than the prescribed value 2, the control part 1 controls the LED 9 to be turned on with a second quantity of light larger than the first quantity of light.

In the above description, although the quantity of light of the LED 9 is controlled in three steps, control is not limited to a step-wise method, nor is the number of steps limited to three steps and may be smaller or larger than the three steps in accordance with the image information (luminance signal).

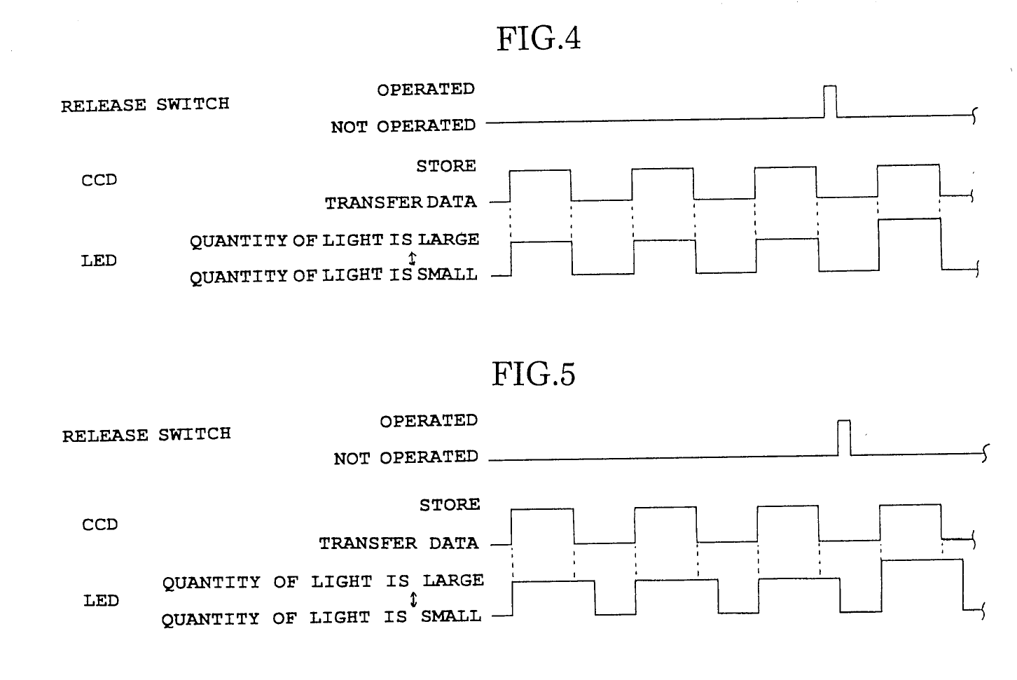

In the photographing mode, the light may be continuously emitted by the LED 9 in a state when the automatic light emitting mode is set, or the light may be emitted only during a period when the CCD 402 stores the electric charge except for a period during transfer of the charge when the charge is read from the CCD 402, as shown in FIG. 4. Alternatively, the LED may be operated in such a manner that the LED is turned off only during a part of a period (during transfer of the charge) when the charge is read from the CCD 402, as shown in FIG. 5. As shown in FIG. 4, if the LED (light emitting part) 9 is turned on only during the period when the CCD 402 stores the charge and is turned off during the period in which the charge is read from the CCD 402, the LED 9 (light emitting part) can be prevented from operating when the CCD 402 is not detecting an image of the object to be photographed. Accordingly, the emission of light not needed for detecting the image of the object to be photographed can be prevented and unnecessary power consumption is avoided. Further, as shown in FIG. 5, if the LED is turned off only during a part of the period when the charge is read from the CCD 402, unnecessary operation of the LED (light emitting part) 9 can be further reduced and electric power consumption can be reduced as compared to a case in which the LED 9 is continuously turned on. Further, when the LED is turned off during a part of the period when the charge is read from the CCD 402, a flicker which may possibly cause discomfort to a person who is exposed to light from the LED (light emitting part) 9 due to the intermittent light emission of the LED (light emitting part) 9 can be reduced more than a case in which the light emission of the LED 9 is stopped during the entire period of time when the charge is being read from the CCD 402.

In this embodiment, when the above-described light emission of the LED 9 is controlled, the control part 1 controls the light emitting timing of the LED 9 in accordance with the output of the timing generator 404 for regulating the reading timing of the CCD 402. In such a manner, since the reading timing of the CCD 402 and the light emitting control timing of the LED 9 are controlled on the basis of a common output, the synchronization of timing can be easily obtained. Further, since the reading timing of the CCD 402 and the light emitting timing of the LED 9 are controlled on the basis of the common output, an output for determining the timing can be shared. During this time, that is, during a period until the release switch is operated, the quantity of light outputted from the LED 9 is set to a quantity of light not larger than a quantity of light required for photographing a still image by which a photographer can visually recognize a display by the LCD 6.

While a user changes the direction of the portable telephone or the CCD camera 4 in this state; that is, a state in which an image picked up by the CCD camera 4 is displayed on the LCD 6 substantially in real time (a photographing state), the user changes the composition of the image displayed on the LCD 6 and operates the release switch 12 when a desired composition is obtained to perform a still image photographing operation.

The control part 1 changes the quantity of light emitted by the LED 9 from a state before the release switch 12 is operated in accordance with the operation of the release switch 12. Specifically, the control part 1 outputs to the driving circuit 10 a light quantity control signal to increase the quantity of light emitted by the LED 9 immediately after the release switch 12 is operated (in other words, the quantity of light upon photographing the still image) so that the light intensity is greater immediately after the release switch 12 is operated than before the release switch 12 is operated. Specifically, the control part 1 outputs the light quantity control signal for instructing on the quantity of light necessary for photographing the still image, so as to increase the quantity of light emitted by the LED 9. In this case, the release switch 12 is a two-step switch. When the switch of a first-step is turned on in accordance with the operation of the release switch 12, the quantity of light of the LED 9 is increased more than the quantity of light of the LED 9 during a period before the release switch is operated. When the switch of a second step is turned on in accordance with the subsequent operation of the release switch 12, a YUV signal stored in the DRAM 410 is fixed to perform the above-described processes.

As described above, when the still image is photographed in accordance with the operation of the release switch 12, the quantity of light which is necessary for photographing the still image is generated by the LED (light emitting part) 9. In the case of a composition which is not intended by a user during a period until the release switch 12 is operated, unnecessary and wasteful consumption of power due to the generation of more light by the LED 9 than is necessary can be avoided so as to reduce overall power consumption.

As control systems for controlling the quantity of light, when a plurality of LEDs are provided, the number of LEDs 9 to be turned on may be changed or a driving current supplied to the same LED may be changed depending on the quantity of light. These systems may be combined together. In the case of a structure in which the quantity of light from the LED is controlled by changing the driving current supplied to the LED, the quantity of light can be controlled in the same LED. In the case of the structure in which the plural LEDs are provided and the quantity of light from the LEDs is controlled by changing the number of LEDs to be driven, the control of the quantity of light at least corresponding to the number of LEDs can be performed and the quantity of light can be increased more than that in the case of a single LED.

When the quantity of light of the LED 9 is increased in accordance with operation of the release switch 12, the control part 1 fixes the YUV signal stored in the DRAM 410 after the quantity of light of the LED 9 is increased, fetches the fixed YUV signal through the DRAM interface 409 and fixes the display of the LCD 6 to an image corresponding to the fixed YUV signal. The control part 1 applies, for instance, a JPEG encoding process to the fetched YUV signal, and then stores the signal in the flash memory of the memory 8.

As described above, since the LED is used as the light emitting part for lighting an object to be photographed, the light emitting part can be made compact. Accordingly, the degree of freedom of design is improved. Further, since the LED is easily controlled to emit light differently from the way a xenon tube does, the LED may be used as means for providing other than stroboscopic light during photographing an object in the dark. For instance, in dark ambient light, the LED may be used to illuminate an object to be photographed so that a user can recognize a composition. Accordingly, the maneuverability of the user is increased. Further, since the LED does not require a driving voltage of several hundred volts as does a xenon tube, noise resulting from the high voltage can be reduced and a limitation in design due to such noise can be eliminated.

The control part 1 performs a control operation to increase the luminance of image information by increasing the quantity of light emitted by the LED 9 when the luminance obtained from the image information output by the CCD camera 4 is low, or to lower the luminance of the image information by decreasing the quantity of light emitted by the LED when the luminance obtained from the image information output by the CCD camera 4 is too high. Thus, the luminance of the image information is corrected.

Further, since the LCD panel 6 displays an image corresponding to the object to be photographed as illuminated by the LED 9, when the user determines a composition by viewing the display part, illuminating light can be applied thereto. Thus, the user can easily determine a desired composition even in low ambient light by viewing the display part.

Further, since the light emitting part serves as auxiliary light during image composition and as so-called stroboscopic light for photographing at the time of operation of the release switch, the structure can be simplified.

When the photographing mode is set by the operating mode setting part, if the light emitting inhibit mode is set by the light emitting mode setting part 11, the control part 1 controls the LED 9 not to emit light and carries out the above-described photographing operation.

In the foregoing description, although a CCD is employed as the image pick-up part, the present invention is not limited thereto and any type of image sensor such as a CMOS sensor may be used.

In accordance with the above description, although an embodiment is described in which the image pick-up device is formed integrally with a portable electronic device comprising a portable telephone, the portable electronic device is not limited to the portable telephone. For instance, a different type of wireless communication device may be used, as may a notebook or hand-held personal computer or a portable information terminal.

According to the present invention, since the quantity of light of the light emitting part is changed between a period until the release switch is operated and a moment when the still image is photographed in accordance with the operation of the release switch, the quantity of light necessary only for photographing the still image can be applied upon photographing the still image, and before the still image is photographed, the light emitting part may emit light with the quantity of light not larger than the quantity of light necessary for photographing by which a photographer can recognize the object to be photographed. Accordingly, electric power can be saved more than the case where the quantity of light necessary for photographing is continuously applied to the object to be photographed.

We claim:

1. An image pick-up device comprising:
a release switch for outputting a photographing instruction for photographing a still image;
an image pick-up part for picking up an image of an object to be photographed, updating and outputting image information corresponding to the picked-up image until the photographing instruction is output by the release switch, and outputting still image information corresponding to the image of the object picked up when the photographing instruction is output by the release switch;
a light emitting part for illuminating the object to be photographed; and
a light quantity control part for changing the quantity of light emitted by the light emitting part between a period when the release switch is initially operated and a time when the still image is photographed in accordance with the photographing instruction output by the release switch.

2. An image pick-up device according to claim 1; wherein the light quantity control part increases the quantity of light emitted by the light emitting part after the photographing instruction has been output by the release switch so that more light is emitted after the photographing instruction has been output than before the photographing instruction has been output.

3. An image pick-up device according to claim 2; further comprising a display part for displaying an image corresponding to the image information output by the image pick-up part.

4. An image pick-up device according to claim 3; wherein the light emitting part is an LED.

5. A portable electronic device equipped with the image pick-up device according to claim 4.

6. A portable electronic device equipped with the image pick-up device according to claim 3.

7. An image pick-up device according to claim 2; wherein the light emitting part is an LED.

8. A portable electronic device equipped with the image pick-up device according to claim 2.

9. An image pick-up device according to claim 1; further comprising a display part for displaying an image corresponding to the image information output by the image pick-up part.

10. An image pick-up device according to claim 1; wherein the light emitting part is an LED.

11. A portable electronic device equipped with the image pick-up device according to claim 1.

12. An image pick-up device according to claim 1; wherein the light emitting part performs an automatic light emitting operation by controlling the quantity of light emitted in accordance with the image information output by the image pick-up part.

13. An image pick-up device according to claim 1; wherein the quantity of light emitted by the light emitting part is controlled in accordance with a luminance signal included in the image information output by the image pick-up part.

14. An image pick-up device according to claim 13; wherein the quantity of light emitted by the light emitting part is controlled so that the quantity of light is increased in accordance when the luminance signal indicates a darker state.

15. A hand-held wireless communication device comprising: a housing; a receiver contained in the housing for receiving a signal containing data; a transmitter contained in the housing for transmitting a signal containing data; an image pick-up device provided on the housing for obtaining an image of an object and outputting a corresponding image signal; a light emitting device for generating a light to illuminate the object; and a control part for controlling the receiver, the transmitter, the image pick-up device, and the light emitting device.

16. A hand-held wireless communication device according to claim 15; further comprising a display controlled by the control part for displaying an image contained in the image signal.

17. A hand-held wireless communication device according to claim 15; wherein the image pick-up device comprises a CCD camera.

18. A hand-held wireless communication device according to claim 15; wherein the image pick-up device is movably mounted to the housing.

19. A hand-held wireless communication device according to claim 15; wherein the image pick-up device is mounted to the housing such that a lens of the image pick-up device is pivotable about an axis.

20. A hand-held wireless communication device according to claim 15; wherein the control part controls the light emitting part to emit light during an image pick-up operation.

21. A hand-held wireless communication device according to claim 20; wherein the control part controls the light emitting part to emit light during an image composition operation.

22. A hand-held wireless communication device according to claim 21; wherein the control part controls the light emitting part to emit a greater amount of light during a photographing operation than during the image composition operation.
